(19) United States
(12) Patent Application Publication
(10) Pub. No.: US 2009/0079108 A1
(43) Pub. Date: Mar. 26, 2009

(54) PIN TENTER AND SOLUTION CASTING METHOD

(75) Inventor: Takatoshi HORIKAWA, Kanagawa (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/236,544

(22) Filed: Sep. 24, 2008

(30) Foreign Application Priority Data
Sep. 26, 2007 (JP) 2007-248961

(51) Int. Cl. B29D 7/00; B23Q 1/00

(52) U.S. Cl. 264/216; 269/53

(57) ABSTRACT

Each foreign body removing section extends from a position above a pin plate close to a sprocket to a tenter exit, and is located in close proximity to an edge of a wet film, and has a chamber, a brush roller, an air blow suction head, and an adhesive roller section. By contacting the brush roller with a pin plate positioned above the sprocket, fluctuations in disengaging positions of pins are prevented. An impact caused by disengaging the pins from the wet film is reduced. Thus, foreign bodies, namely burrs separated from the wet film, are reduced. The air blow suction head removes foreign bodies by suction. The adhesive roller section removes the residual foreign bodies. Thus, foreign bodies are securely removed. Covering a disengaging area of the pins with the chamber prevents spreading of foreign bodies into a product area and failures caused by foreign bodies.

### FIELD OF THE INVENTION

The present invention relates to a pin tenter which conveys and dries a web while holding side edge portions of the web in a width direction with pins, and a solution casting method using the pin tenter.

### BACKGROUND OF THE INVENTION

Polymer films have excellent optical transparency and flexibility, and can be formed into thin and lightweight films. Therefore, the polymer films are used as optical functional films for various uses. In particular, cellulose ester films produced from cellulose acylate and the like have strength and low birefringence in addition to the above properties. The cellulose ester films are used as protection films and optical compensation films for polarizing filters used in liquid crystal displays (LCDs), whose market is expanding, and photosensitive films.

A solution casting method is one of production methods for polymer films. According to the solution casting method, a dope containing a polymer and a solvent is cast from a casting die onto a support and a casting film is formed. After the casting film obtains a self-supporting property, the casting film is peeled from the support as a wet film. Hereinafter, the wet film is also referred to as web. Next, the wet film is dried through a tenter and a residual solvent content of the wet film is reduced. Thus, a film is produced. Then, both side edge portions of the film are cut off and the film is further dried in a drying device. Thereafter, the film is wound by a winding device.

There are pin tenters and clip tenters, according to whether they use pins or clips for holding side edge portions of the wet film or the film. The pin tenter has a pair of endless chains, which circulate continuously, pin plates attached to each endless chain, and a plurality of pins arranged on each pin plate. When the wet film enters the pin tenter, the side edge portions of the wet film are pierced and held by the pins. As the endless chains circulate continuously, the wet film is dried while passing through each drying zone in a drying chamber under appropriate tension (see Japanese Patent Laid-Open Publication No. 09-077315).

As resolution of LCDs become higher, optical films free from thickness unevenness, scratches, and foreign bodies are demanded. In a solution casting apparatus, foreign bodies tend to adhere on the wet film in a disengaging area, namely, a position where pins are disengaged from the wet film and its vicinity. The foreign bodies include burrs of the wet film around the pins, generated by piercing the pins into the wet film, and foreign bodies adhered to side edges of the wet film in various process steps. In the disengaging area, such foreign bodies spread into a product area that is a center portion of the wet film in the film width direction on the impact of disengaging the pins from the wet film, and frequently causes defects on the wet film. Additionally, in the case the wet film to which the foreign bodies are adhered passes through rollers, small dents are formed on the wet film. Therefore, improvements in reduction of the foreign bodies are desired.

### SUMMARY OF THE INVENTION

In view of the foregoing, an object of the present invention is to provide a pin tenter that prevents generation and adhesion of foreign bodies in a disengaging area where pins are disengaged from a web located in the vicinity of an exit of the pin tenter and a solution casting method.

A pin tenter of the present invention has a pair of guide tracks each of which has a rail and a sprocket disposed in a conveying direction of the web, a chain provided to each guide track and circulating around the guide track, a pin plate attached to each chain and having a plurality of pins, and a foreign body removing section for removing foreign bodies from a side edge portion of the web. The foreign body removing section is provided in close proximity to a disengaging area where the pins are disengaged from the web and located above the sprocket, and the web downstream from the disengaging area. In the tenter, the web is dried while being conveyed in a state that side edge portions of the web are held by the plurality of pins.

It is preferable that the foreign body removing section is provided with at least one of a brush roller, an air blow suction head, and an adhesive roller. It is preferable that the foreign body removing section has a chamber for covering the side edge portion of the web, the brush roller, the air blow suction head, and the adhesive roller, and in the chamber, the brush roller, the air blow suction head and the adhesive roller are disposed in this order in a web conveying direction. It is preferable that the brush roller is disposed above the disengaging area, and presses from above the web held by the pins located above the sprocket.

A solution casting method of the present invention has the following steps: forming a casting film by casting a dope containing a polymer and a solvent on a support; peeling the casting film from the support as a web after the casting film obtains a self-supporting property; conveying and drying the web while the side edge portions of the web are held by a plurality of pins of the above-described pin tenter.

According to the present invention, the foreign body removing section is provided in close proximity to the disengaging area where the pins are disengaged from the web, and the web downstream from the disengaging area. Thereby, adhesion of foreign bodies to a product area in the center of the web in the width direction is prevented and failures caused by foreign bodies are eliminated.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention.

In the drawings, like reference numerals designate like or corresponding parts throughout the several views, and wherein:

FIG. 1 is a schematic view of a solution casting apparatus;

FIG. 2 is a schematic lateral view of a pin tenter of the present invention;

FIG. 3 is a schematic lateral view of a disengaging area and a foreign body removing section; and

FIG. 4 is a schematic plane view of the disengaging area and the foreign body removing section.

### DESCRIPTION OF THE PREFERRED EMBODIMENT

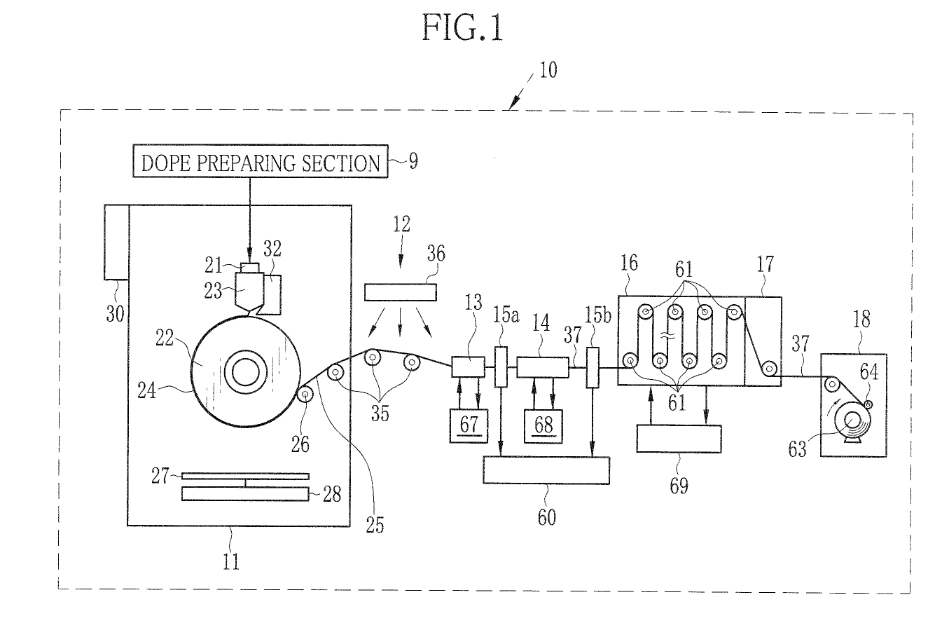

As shown in FIG. 1, a solution casting apparatus 10 is constituted of a dope preparing section 9, a casting chamber 11, a transfer section 12, a pin tenter 13, a clip tenter 14, first and second edge slitting devices 15a and 15b, a drying device 16, a cooling device 17, and a winding device 18.

The casting chamber 11 is provided with a feed block 21, a drum 22 as a support for casting, a casting die 23, a peel roller 26, a condenser 27, and a recovery device 28. A dope is fed from the dope preparing section 9 to the feed block 21. The dope is cast from the casting die 23 onto the drum 22. The peel roller 26 peels a casting film 24 from the drum 22 as a wet film 25. The condenser 27 condenses and liquefies solvent vapors evaporated from the casting film 24 and the wet film 25. The recovery device 28 recovers liquefied solvent. A heat transfer medium supplying device (not shown) is connected to the drum 22. A surface temperature of the drum 22 is adjusted at a desired temperature by supplying the heat transfer medium inside the drum 22. A temperature controller 30 is attached to the casting chamber so as to adjust the inner temperature of the casting chamber 11.

Inside the feed block 21, a flow path of the dope is formed. The casting film 24 with a desired configuration is formed by adjusting an arrangement of the flow path. A decompression chamber 32 is attached to the casting die 23. The decompression chamber 32 reduces pressure in an area upstream from a bead with respect to a rotating direction of the drum 22 to stabilize the contact of the bead to the drum 22. The bead is a dope between the casting die 23 and the drum 22.

The drum 22 is a stainless steel drum capable of being continuously rotated. The surface of the drum 22 is polished. Thereby, the casting film 24 with excellent planarity is formed on the drum 22. In this embodiment, the drum 22 is used as the support. However, the support is not particularly limited. For example, an endless casting belt which is looped around a pair of rollers and moved continuously may be used as a support. The material of the support is stainless steel having corrosion-resistance and high strength.

The transfer section 12 is constituted of a plurality of rollers 35 and a dry air duct 36. After the wet film 25 is peeled from the drum 22, the rollers 35 convey the wet film 25 to the pin tenter 13. The dry air duct 36 is provided above a conveying path of the wet film 25. The dry air duct 36 blows dry air onto the wet film 25, promoting drying of the wet film 25.

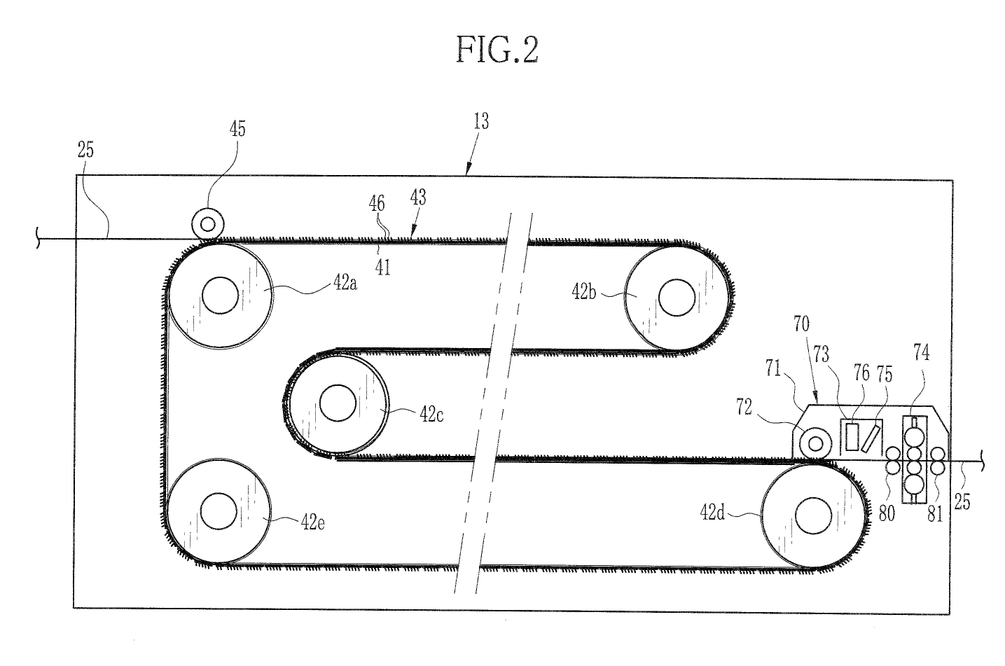

As shown in FIG. 2, the pin tenter 13 has a pair of endless chains 41 looped around sprockets 42a to 42e, and pin plates 43 attached to each of the endless chains 41 at appropriate intervals.

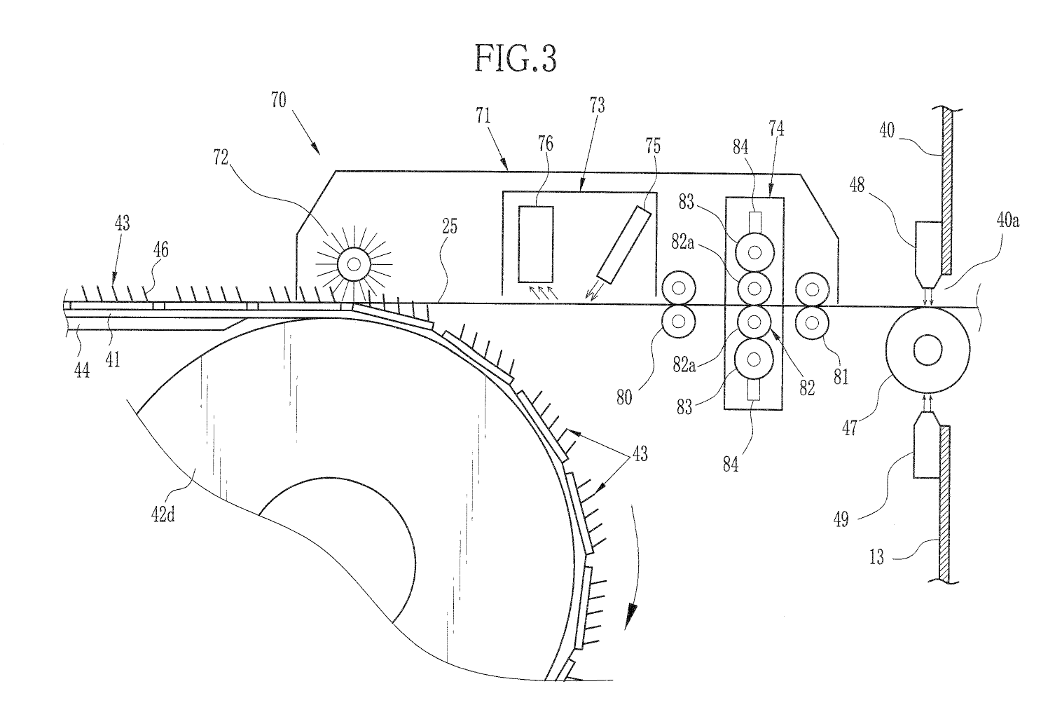

As shown in FIG. 3, each of the endless chains 41 is supported by a rail 44 so as not to fall off in any direction. Each rail 44 has divided rail sections with a certain length so as to control tension of the wet film 25 in the width direction. Adjacent divided rail sections are connected at the ends through a pin. To change a distance between rails 44, the opposing pin-connected divided rail sections are shifted in a film width direction by a shifting mechanism. The endless chain 41 is circulated on the rail 44 by a chain driving section (not shown).

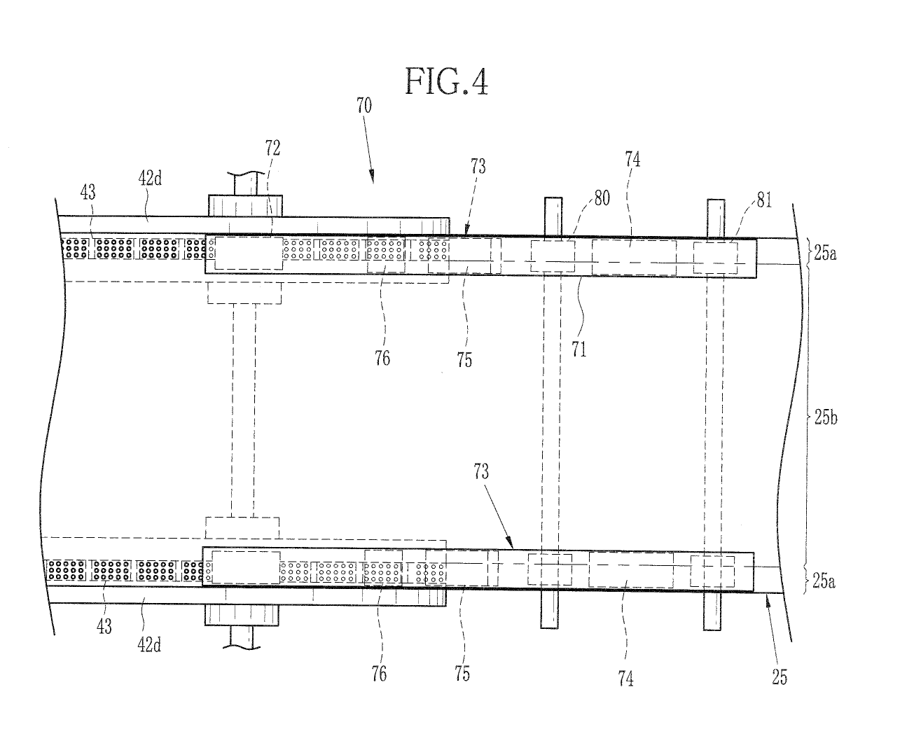

As shown in FIGS. 3 and 4, a plurality of pins 46 are attached to each pin plate 43. As shown in FIG. 2, at an entrance of the pin tenter 13, a brush roller 45 is provided above the sprocket 42a located on the entrance side. The brush roller 45 contacts upper surfaces of the side edge portions (hereinafter edges) 25a of the wet film 25 and pushes the edges 25a onto the pins 46. Thereby, the edges 25a are pierced by pins 46, and the wet film 25 is dried while the pin plates 43 apply tension to the wet film 25 in the width direction.

At a film exit 40a of the pin tenter 13, a film supporting roller 47, and air curtains 48 and 49 are provided so as to prevent solvent vapors from leaking out of the pin tenter 13.

As shown in FIG. 1, the clip tenter 14 is provided downstream from the pin tenter 13. After being discharged from the pin tenter 13, the wet film 25 is dried while being conveyed in the clip tenter 14 in a state that the edges 25a of the wet film 25 are held. Thereby, a film 37 is produced. The clip tenter 14 provided downstream from the pin tenter 13 is often used for imparting additional optical properties to the film 37. In the case the additional optical properties are unnecessary, the clip tenter 14 can be omitted.

The first edge slitting device 15a cuts off edges of the wet film 25 discharged from the pin tenter 13. The second edge slitting device 15b cuts off edges of the film 37 discharged from the clip tenter 14. The first and the second edge slitting devices 15a and 15b are connected to a crusher 60. The crusher 60 crushes the cut-off edges of the wet film 25 and the film 37 into chips.

The film 37 is sent to the drying device 16 through the second edge slitting device 15b Inside the drying device 16, a plurality of rollers 61 are arranged. The film 37 is dried while being conveyed by the rollers 61. The film 37 discharged from the drying device 16 is sent to the cooling device 17, and then cooled to approximate room temperature in the cooling device 17.

The winding device 18 has a winding shaft 63. After being discharged from the cooling device 17, the film 37 is wound in a roll around a winding core set on the winding shaft 63. The winding device 18 has a press roller 64. The press roller 64 controls tension applied to the film 37 being wound around the winding core.

Solvent vapors evaporated from the wet film 25 and the film 37 in the pin tenter 13, the clip tenter 14, and the drying device 16 are adsorbed and recovered by the adsorption recovery devices 67 to 69 provided outside the pin tenter 13, the clip tenter 14, and the drying device 16, and reused.

Thus, the film 37 with the excellent planarity is stably produced at high speed. It is preferable that the width of the film 37 produced in this embodiment is at least 1400 mm and at most 2500 mm. The present invention is effective even if the width of the film 37 is larger than 2500 mm. The thickness of the film 37 produced in this embodiment is preferably at least 20 μm and at most 100 μm, more preferably at least 20 μm and at most 80 μm, and most preferably at least 30 μm and at most 80 μm.

Next, a foreign body removing section 70 of the pin tenter 13 is described while referring to FIGS. 2 to 4. The foreign body removing section 70 is a characterizing feature of the present invention. As shown in FIG. 2, each foreign body removing section 70 is provided immediately above the edge 25a in the vicinity of the film exit 40a of the pin tenter 13. The foreign body removing section 70 extends from a disengaging area to the downstream from the disengaging area. The disengaging area is an area including a position where the pins 46 are disengaged from the edge 25a and its vicinity. Each foreign body removing section 70 is has a chamber 71 for removing foreign bodies, and in the chamber 71, a brush roller 72, an air blow suction head 73, and an adhesive roller section 74.

As shown in FIGS. 3 and 4, each chamber 71 covers the edge 25a of the wet film 25 from an area above the sprocket 42d to the close vicinity of the film exit 40a of the pin tenter 13. Air inside the chamber 71 is sucked through a suction duct (not shown), and thereby the chamber 71 is kept under negative pressure so as not to spread foreign bodies into a product area 25b from the chamber 71. The product area 25b is an, area of the wet film 25 between the edges 25a. Each chamber 71 has an adequate width for covering the edge 25a. In this embodiment, the chamber 71 has the adequate width for covering an area having the width of 400 mm from the edge 25a.

In the chamber 71, the brush roller 72, the air blow suction head 73, and the adhesive roller section 74 are disposed in this order from the upstream in the film conveying direction.

The brush roller 72 comes in contact with the wet film 25 when the pin plates 43 move toward a lower diagonal position so as to be disengaged from the edges 25a in association with the rotation of the sprocket 42d. Thereby, the edges 25a are constantly retained at a given position in a vertical direction, and fluctuations of the disengaging position of the pins 46 are prevented. As a result, conventional fluctuations of the disengaging position in the conveying direction, resulting in an impact which disengages the pins 46 from the wet film 25 outside the disengaging area are prevented. At the same time, the brush roller 72 separates burrs from the wet film 25. With the use of the chamber 71, the separated burrs are prevented from spreading into the product area 25b (see FIG. 4).

The air blow suction head 73 has a blowoff nozzle 75 and a suction nozzle 76. Foreign bodies are blown off from the edges 25a with air from the blowoff nozzle 75, and vacuumed by the suction nozzle 76. Thus, the foreign bodies on the wet film 25 are removed. The foreign bodies include those adhered to the casting film 24 and the wet film 25 during each process step and burrs separated from the wet film 25 in the vicinity of the pin hole upon contact of the brush roller 72.

The adhesive roller section 74 has a pair of first nip rollers 80 and a pair of second nip rollers 81, and a pair of adhesive rollers 82 disposed between the pairs of the first and the second nip rollers 80 and 81. Each of the pairs of the nip rollers 80 and 81 sandwich the edge 25a from above and below so as to stably convey the edge 25a disengaged from the pins 46. Each of the adhesive rollers 82 has an adhesive surface 82a. The adhesive surfaces 82a come in contact with the upper and lower surfaces of the edge 25a. Thereby, the foreign bodies on the edge 25a adhere to the adhesive surfaces 82a. Thus, the foreign bodies on the edge 25a are removed. The foreign bodies adhered to each of the adhesive surfaces 82a are removed by a foreign body removal roller 83. The foreign bodies adhered to each of the foreign body removal rollers 83 are removed by suction of a suction head 84. The foreign bodies collected by adhesion of the pair of adhesive rollers 82 may be removed using removal sheets or suction heads instead of or in addition to the use of the foreign body removal rollers 83.

The chamber 71 having at least one of the brush roller 72, the air blow suction head 73, and the adhesive roller section 74 is effective at removing the foreign bodies. The chamber 71 having at least two of the above brush roller 72, the air blow suction head 73, and the adhesive roller section 74 achieves a synergistic effect of removing the foreign bodies, and thereby the foreign bodies are effectively and securely removed.

In particular, the foreign bodies are securely removed from the edge 25 by providing the brush roller 72, the air blow suction head 73, and the adhesive roller section 74 in this order in the film conveying direction. Burrs on the edge 25a are positively separated by the brush roller 72, and the separated burrs are removed by suction of the air blow suction head 73. Residues of the suction are securely collected by the adhesive roller section 74 and removed from the edge 25a. Thus, the foreign bodies are securely removed. By using the adhesive roller section 74 alone without the brush roller 72 and the air blow suction head 73, large-sized foreign bodies and the wet film 25 can be nipped together by the pair of adhesive rollers 82, and dents (concave portions) can be formed on the wet film 25 by the large-sized foreign bodies. Formation of such dents on the wet film 25 in the adhesive roller section 74 is avoided by removing in advance the large-sized foreign bodies with the use of the brush roller 72 and the air blow suction head 73.

By providing the brush roller 72, the air blow suction head 73, and the adhesive roller section 74 in the chamber 71, the foreign bodies on each edge 25a are prevented from spreading into the product area 25b. Since the chamber 71 is under negative pressure by suction, the foreign bodies in the chamber 71 are discharged to the outside of the chamber 71 by suction without spreading, and collected by a dust collector such as a filter.

Each foreign body removing section 70 can be provided with plural brush rollers 72, plural air blow suction heads 73, and plural adhesive roller sections 74, for example two each, in the film conveying direction. Instead of the adhesive roller section 74, two each of the brush rollers 72 and the air blow suction heads 73 can be provided in the film conveying direction. The air blow suction head 73 can be provided above the product area 25b in addition to the areas of the both edges 25a.

In the above embodiment, only the adhesive roller section 74 is provided below each edge 25a. Alternatively, the chamber 71, the brush roller 72, and the air blow suction head 73 and the like can be provided below the edge 25a. Thereby, the foreign bodies are more efficiently removed, and prevented from spreading.

In the above embodiment, the foreign body removing section 70 is constituted of the brush roller 72, the air blow suction head 73, and the adhesive roller section 74. Instead of or in addition to them, neutralized air, plasma processing, washing under running water or the like can be used for removal of the foreign bodies. The foreign body removing section 70 can be extended to the upstream from the disengaging area.

In the above embodiment, the present invention is applied to the pin tenter 13 of the solution casting apparatus 10. The present invention is applicable to a pin tenter of any type, and various apparatuses for producing webs and films.

In the above embodiment, a single layer film is produced from one kind of dope. The present invention is also effective in producing a casting film with a multilayer structure. In this case, any known method is used for casting a desired number of dopes simultaneously or sequentially and the method to be used is not particularly limited. Paragraphs from [0617] to [0889] of Japanese Patent Laid-Open Publication No. 2005-104148 detail the structures of the casting die, the decompression chamber and the support, co-casting, peeling, stretching, drying condition in each process, handling methods, curling, winding methods after the correction of planarity, recovering methods of a solvent, and recovering methods of a film, and the inventions according to the above descriptions can be applied to the present invention. Properties of the produced film, degrees of curling, thickness, and measuring methods thereof are disclosed in paragraphs from [1073] to [1087] of Japanese Patent Laid-Open Publication No. 2005-104148, and the inventions according to the above descriptions can be applied to the present invention.

The produced film 37 can be used as a functional film by providing a desired functional layer to at least one of the surfaces. Examples of the functional layer include an antistatic layer, a curable resin layer, an anti-reflection layer, an easy-adhesion layer, an anti-glare layer, optical compensation layer and the like. For example, an anti-reflection film is produced by providing the anti-reflection layer to the produced film 37. The anti-reflection film prevents reflection of light and offers high image quality. The above described functional layers and forming methods thereof are detailed in paragraphs from [0890] to [1072] of Japanese Patent Laid-Open Publication No. 2005-104148, and inventions according to the above descriptions can be applied to the present invention. Specifically, the polymer film is used in TN type, STN type, VA type, OCB type, reflection type, and other types of the LCDs disclosed in, for example, paragraphs [1088] to [1265] of Japanese Patent Laid-Open Publication No.2005-104148.

Next, examples of raw materials of the dope produced in the dope preparing section 9 are described.

It is preferable to use cellulose ester as the raw material of the dope so as to produce the film, with high degree of transparency. Cellulose ester contained in the dope is, for example, lower fatty acid ester of cellulose, such as cellulose triacetate, cellulose acetate propionate, or cellulose acylate butyrate. In order to form a film with excellent optical transparency, cellulose acylate is preferable, and cellulose triacetate (TAC) is especially preferable. The dope used in the above embodiment contains TAC as the polymer. It is preferable to use TAC particles at least 90 wt. % of which have the diameter of 0.1 mm to 4 mm.

It is preferable that a degree of substitution of acyl groups for hydrogen atoms on hydroxyl groups in cellulose acylate preferably satisfies all of the following mathematical expressions (a)-(c) so as to produce a film with a high degree of transparency.
(a) 2.5≦A+B≦3.0
(b) 0≦A≦3.0
(c) 0≦B≦2.9

In these mathematical expressions (a) to (c), A is the degree of substitution of the hydrogen atom of the hydroxyl group for the acetyl group, and B is a degree of substitution of the hydrogen atom of the hydroxyl group for the acyl group with 3 to 22 carbon atoms.

The cellulose is composed of glucose units making β-1,4 combination, and each glucose unit has a free hydroxyl group at second, third and sixth positions. Cellulose acylate is a polymer in which a part of or the entire of the hydroxyl groups are esterified so that the hydrogen is substituted by acyl group with two or more carbons. The degree of substitution for the acyl groups in cellulose acylate is a degree of esterification of the hydroxyl group at second, third or sixth position in cellulose. Accordingly, when all (100%) of the hydroxyl groups at the same positions are substituted, the degree of substitution at this position is 1.

When the degrees of substitution of the acyl groups for the hydroxyl group at the second, third or sixth positions per glucose unit are respectively described as DS2, DS3 and DS6, the total degree of substitution of the acyl groups for the hydroxyl group at the second, third and sixth positions (namely DS2+DS3+DS6) is preferably in the range of 2.00 to 3.00, more preferably in the range of 2.22 to 2.90. It is especially preferable that DS2+DS3+DS6 is in the range of 2.40 to 2.88. In addition, DS6/(DS2+DS3+DS6) is preferably at least 0.28, and more preferably 0.30. It is especially preferable that DS6/(DS2+DS3+DS6) is in the range of 0.31 to 0.34.

One or more kinds of acyl group may be contained in the cellulose acylate. In the case two or more kinds of the acyl groups are used, it is preferable that one of them is acetyl group. If the total degree of substitution of the acetyl groups for the hydroxyl group and that of acyl groups other than the acetyl group for the hydroxyl group at the second, third or sixth positions are respectively described as DSA and DSB, it is preferable that the value DSA+DSB is in the range of 2.22 to 2.90. It is especially preferable that the value DSA+DSB is in the range of 2.40 to 2.88.

It is preferred that the DSB is at least 0.30, and especially preferred that the DSB is at least 0.70. Further, the percentage of the substituent for the hydroxyl group at the sixth position in DSB is preferred to be at least 20%, more preferred to be at least 25%, further more preferred to be at least 30%, and especially preferred to be at least 33%. Further, a value DSA+DSB at the sixth position of cellulose acylate is preferred to be at least 0.75, more preferred to be at least 0.80, and especially preferred to be at least 0.85. A dope having excellent solubility is prepared using cellulose acylate satisfying the above conditions. Especially when non-chlorine type solvent is used with the above-described cellulose acylate, a dope having excellent solubility, low viscosity, and excellent filterability is prepared.

Acyl group having at least 2 carbon atoms in cellulose acylate may be aliphatic group or aryl group, and is not especially restricted. Examples of the cellulose acylate include alkylcarbonyl ester, alkenylcarbonyl ester, aromatic carbonyl ester, aromatic alkylcalbonyl ester and the like. Additionally, the cellulose acylate can be esters having other substituents. More preferable substituents include propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Of those, propionyl group, butanoyl group, dodecanoyl group, octadecanoyl group, t-butanoyl group, oleoyl group, benzoyl group, naphtyl carbonyl group, cinnamoyl group and the like are particularly preferable. Especially preferable substituents include propionyl group and butanoyl group.

The cellulose acylate usable in the present invention are detailed in paragraphs from [0140] to [0195] in Japanese Patent Laid-Open Publication No. 2005-104148, and the above descriptions can be applied to the present invention.

A solvent as one of the raw materials of a dope is preferred to be an organic compound capable of dissolving polymer being used. In the present invention, a dope is a mixture produced by dissolving or dispersing polymer in a solvent. Therefore, solvents having low solubility for polymer may also be used. Preferable solvent compounds are, for example, aromatic hydrocarbon such as benzene and toluene, halogenated hydrocarbons such as dichloromethane, chloroform, and chlorobenzene, alcohols such as methanol, ethanol, n-propanol, n-butanol, and diethylene glycol, ketones such as acetone and methylethyl ketone, esters such as methylacetate, ethylacetate, and propylacetate, ethers such as tetrahydrofuran, and methylcellosolve, and the like. It is also possible to use a solvent mixture in which two or more kinds of the above solvent compounds are mixed. Among the above solvent compounds, dichloromethane is preferable. With the use of dichloromethane, the dope with excellent solubility is produced, and the solvents contained in the casting film are evaporated in a short time to form a film.

Among the above halogenated hydrocarbons, those having 1 to 7 carbon atoms are preferable. In view of physical properties such as compatibility with polymer, peelability that is an index indicating ease of peeling a casting film from a support, mechanical strength, and optical properties of the film, it is preferable to use a mixture of dichloromethane and at least one kind of alcohol having 1 to 5 carbon atoms. The content of the alcohol is preferably in the range of 2 wt. % to 25 wt. %, and more preferably in the range of 5 wt. % to 20 wt. % to the total solvent compounds in the solvent. Specific examples of the alcohol include methanol, ethanol, n-propanol, isopropanol, n-butanol, and the like. In particular, it is preferable to use methanol, ethanol, n-butanol or a mixture thereof.

In order to minimize the influence on the environment, a solvent composition not containing dichloromethane is suggested. In this case, the solvent containing ethers with 4 to 12 carbon atoms, ketones with 3 to 12 carbon atoms, esters with 3 to 12 carbon atoms, or a mixture of them may be used. The above-mentioned compounds may have cyclic structures. A solvent compound having at least two functional groups of ether, ketone, and ester (namely, —O—, —CO—, and —COO—) may be used as a solvent. The solvent may contain other functional group such as an alcoholic hydroxyl group. In the case the solvent compound contains two or more kinds of functional groups, the number of carbons is not particularly limited as gong as it is within a specified limit of a compound having any one of the functional groups.

Well-known additives such as plasticizers, UV absorbents (UV agents), deterioration inhibitors, lubricating agents, and peeling improvers may be added to the dope according to the purpose. Well-known plasticizers maybe used, for example, phosphoric acid ester plasticizers such as triphenyl phosphate and biphenyl diphenyl phosphate, phthalic acid ester plasticizers such as diethyl phthalate, and polyester polyurethane elastomer and the like.

It is preferable to add fine particles to the dope so as to adjust a refractive index of the film and prevent adhesion of the films. It is preferable to use silicon dioxide derivatives as the fine particles. The term “silicon dioxide derivatives” of the present invention includes silicon dioxide and silicone resin having three-dimensional network structures. The silicon dioxide derivatives with the alkylated surfaces are preferable. Hydrophobized particles such as alkylated particles have excellent dispersibility in the solvent. As a result, the dope is prepared and the film is produced without coagulation of the fine particles. Thereby, the film with a high degree of transparency with few surface defects is produced.

An example of the above-described fine particles with the alkylated surfaces is commercially available Aerosil R805 (produced by Degussa Japan, Co., Ltd.), which is a silicon dioxide derivative introduced with octyl group on the surface. In order to produce the film with a high degree of transparency while the effectiveness of the fine particles is ensured, the content of the fine particles with respect to the solid content of the dope is preferably at most 0.2%. In addition, in order to prevent the fine particles from interfering with light, the average particle diameter is preferably at most 1.0 μm and more preferably 0.3 μm to 1.0 μm, and most preferably 0.4 μm to 0.8 μm.

As described above, it is preferable to use TAC as the polymer to produce the polymer film having excellent optical transparency. In this case, a ratio of TAC is preferably 5 wt. % to 40 wt. %, and more preferably 15 wt. % to 30 wt. %, and especially preferably 17 wt. % to 25 wt. % with respect to a total amount of the dope mixed with solvents and additives. A ratio of the additives (mainly plasticizers) is preferably 1 wt. % to 20 wt. % with respect to the whole solid content including polymer and other additives contained in the dope.

Solvents, additives such as plasticizers, UV absorbents, deterioration inhibitors, lubricating agents, peeling improvers, optical anisotropy controllers, retardation controllers, dyes, and peeling agents, and fine particles are detailed in paragraphs from [0196] to [0516] of Japanese Patent Publication No. 2005-104148, and the above descriptions can be applied to the present invention. In addition, producing methods of a dope using TAC including, for example, materials, raw materials, dissolution methods and adding methods of additives, filtering methods, and defoaming are disclosed in paragraphs from [0517] to [0616] of Japanese Patent laid-Open Publication No. 2005-104148, and the above descriptions can be applied to the present invention.

### EXAMPLE

The film 37 was produced using the solution casting apparatus 10 shown in FIG. 1. An appropriate amount of the dope was fed from the dope preparing section 9 to the casting die 23 through the feed block 21. The dope was cast from the casting die 23 onto the drum 22 which was rotated continuously. Thus the casting film 24 was formed. The discharge opening of the casting die 23 was a slit having a width of 1.8 m. The temperature of the dope at the casting was 36° C. The inner temperature of the feed block 21 was 36° C. The pressure of the decompression chamber 32 was set at 600 Pa and the pressure of the area upstream from the bead with respect to the rotation direction of the drum 22 was reduced.

The drum 22 was a stainless steel drum capable of controlling the number of rotations. A coolant was supplied from a heat transfer medium supplying device (not shown) to the inside of the drum 22. Thus, the surface temperature of the drum 22 was adjusted at −10° C. The inner temperature of the casting chamber 11 was constantly kept at 35° C. using the temperature controller 30.

The casting film 24 was cooled and gelated. When the casting film 24 obtained the self-supporting property, the casting film 24 was peeled off as the wet film 25 using the peel roller 26. Thereafter, the wet film 25 was sent to the transfer section 12. The wet film 25 was conveyed through the transfer section 12 while being supported by the plurality of rollers 35. During the conveyance, the dry air adjusted at 40° C. was supplied from the dry air duct 36, and the film 37 was dried.

As shown in FIGS. 2 to 4, the foreign body removing section 70 was provided in the disengaging area where the pins 46 are disengaged from the edges 25a of the wet film 25. Foreign bodies on each edge 25a are removed by the combined use of the brush roller 72, the air blow suction head 73, and the adhesive roller section 74.

As shown in FIG. 1, the wet film 25 was sent from the pin tenter 13 to the clip tenter 14. In the clip tenter 14, the wet film 25 was dried while being conveyed in the state that the edges 25a were held. Thus, the film 37 was produced. The edges of the wet film 25 and the film 37 were cut off using the first and the second edge slitting devices 15a and 15b. The cut-off edges of the wet film 25 and the film 37 were sent to the crusher 60 using a cutter blower (not shown), and crushed into chips of approximately 80 mm² in average.

A preheating chamber (not shown) was provided between the edge slitting device 15b and the drying device 16. The film 37 was preheated in the preheating chamber by supplying dry air at 100° C. Thereafter, the film 37 was sent to the drying device 16. In the drying device 16, the film 37 was conveyed while being bridged across the plurality of rollers 61. The film 37 was dried while being conveyed. The inner temperature of the drying device 16 was adjusted to make the surface temperature of the film 37 1400° C. The drying time of the film 37 in the drying device 16 was 10 minutes. The surface temperature of the film 37 was measured using a thermometer (not shown) provided at a position directly above and in close proximity to the film 37. In the drying device 16, solvent vapors evaporated from the film 37 were recovered using the adsorption recovery device 69. The adsorption recovery device 69 had an adsorbing agent which was activated carbon and a desorbing agent which was dry nitrogen. After the solvent vapors were recovered, a water content in the solvent vapors was removed to 0.3 wt. % or less.

A moisture control chamber (not shown) was provided between the drying device 16 and the cooling device 17. Air at the temperature of 50° C. and dew point of 20° C. was supplied to the film 37. Thereafter, air at 90° C. and humidity of 70% was directly blown onto the film 37 to smooth the curls in the film 37. Next, the film 37 was sent to the cooling device 17. The film 37 was gradually cooled down to 30° C. or less.

The film 37 was sent to the winding device 18. The film 37 was wound around the winding shaft 63 with a diameter of 169 mm while 50 N/m of pressure was applied to the film 37 using the press roller 64. A tension at the start of winding was 300 N/m. A tension at the end of winding was 200 N/m. Thus, the film 37 was wound in a roll.

The width of the produced film 37 was 1700 mm. The thickness of the produced film 37 was 80 μm. Average drying speed of the casting film 24 and the film 37 were 20 wt. %/min throughout the film producing process.

The raw materials of the dope used in the example were as follows.

| | | |
|---|---|---|
| cellulose triacetate | 100 | pts. wt |
| dichloromethane | 320 | pts. wt. |
| methanol | 83 | pts. wt. |
| 1-butanol | 3 | pts. wt. |
| plasticizer A | 7.6 | pts. wt. |
| plasticizer B | 3.8 | pts. wt. |
| UV agent a | 0.7 | pts. wt. |
| UV agent b | 0.3 | pts. wt. |
| citric acid ester mixture | 0.006 | pts. wt. |
| fine particles | 0.05 | pts. wt. |

The above cellulose triacetate was powder satisfying the following conditions: the degree of substitution was 2.84, the viscometric average degree of polymerization was 306, the water content was 0.2 wt. %, the viscosity of 6 wt. % of dichloromethane solution was 315 mPa·s, the average particle diameter was 1.5 mm, and the standard deviation of the average particle was 0.5 mm. The plasticizer “A” was triphenylphosphate. The plasticizer “B” was diphenyl phosphate. The UV agent “a” was 2-(2′-hydroxy-3′,5′-di-tert-butylphenyl) benzotriazol and UV agent “b” was 2-(2′-hydroxy-3′,5′-di-tert-amylphenyl)-5-chlorobenzotriazol. The citric acid ester mixture was a mixture of citric acid, citric acid monoethyl ester, citric acid diethyl ester and citric acid triethyl ester. Fine particles were silicon dioxide with average particle diameter of 15 nm and Mohs hardness of approximately 7. At the preparation of the dope, a retardation controller(N-N′-di-m-tolyl-N″-p-methoxyphenyl-1,3,5-triazine-2,4,6-triamine) was added such that the amount of the retardation controller represented 4.0 wt. % of the total amount of the produced film 37.

In the above embodiment, the foreign bodies were removed from the edge 25a of the wet film 25 in the foreign body removing section 70. The number of the foreign bodies was reduced from 168 to 6, compared to a conventional solution casting apparatus without a foreign body removing section. Thus, the number of the foreign bodies was significantly reduced. The result was evaluated by placing an A4-sized cleaning sheet for 40 minutes at the downstream from the disengaging area in the film conveying direction, and the number of the foreign bodies adhered to the cleaning sheet was counted.

Various changes and modifications are possible in the present invention and may be understood to be within the present invention.

What is claimed is:

1. A pin tenter comprising:
a pair of guide tracks, each said guide track having a rail and a sprocket disposed in a conveying direction of a web;
a chain provided to each said guide track and circulating around said guide track;
a pin plate attached to each said chain and having a plurality of pins, said web being dried while being conveyed in a state that side edge portions of said web being held by said plurality of pins; and
a foreign body removing section for removing foreign bodies from said side edge portion of said web, said foreign body removing section being provided in close proximity to a disengaging area where said pins are disengaged from said web and located above said sprocket, and said web downstream from said disengaging area.

2. The pin tenter of claim 1, wherein said foreign body removing section is provided with at least one of a brush roller, an air blow suction head, and an adhesive roller.

3. The pin tenter of claim 2, wherein said foreign body removing section has a chamber for covering said side edge portion of said web, said brush roller, said air blow suction head and said adhesive roller, and in said chamber, said brush roller, said air blow suction head and said adhesive roller are disposed in this order in said web conveying direction.

4. The pin tenter of claim 2, wherein said brush roller is disposed above said disengaging area, and presses from above said web held by said pins located above said sprocket.

5. A solution casting method comprising the steps of:
forming a casting film by casting a dope containing a polymer and a solvent on a support;
peeling said casting film from said support as a web after said casting film obtaining a self-supporting property; and
conveying and drying said web while side edge portions of said web being held by a plurality of pins of a pin tenter, said pin tenter including a pair of guide tracks, each said guide track having a rail and a sprocket disposed in a conveying direction of said web, a chain provided to each said guide track and circulating around said guide track, and a pin plate attached to each said chain and having said plurality of pins, a foreign body removing section for removing foreign bodies from said side edge portion of said web, said foreign body removing section being provided in close proximity to a disengaging area where said pins are disengaged from said web and located above said sprocket, and said web downstream from said disengaging area.
